(19) United States
(12) Patent Application Publication
(10) Pub. No.: US 2014/0143872 A1
(43) Pub. Date: May 22, 2014

(54) METHOD OF DETERMINING WHETHER OR NOT WEBSITE IS MALICIOUS AT HIGH SPEED

(71) Applicant: KOREA INTERNET & SECURITY AGENCY, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: KOREA INTERNET & SECURITY AGENCY, Seoul (KR)

(21) Appl. No.: 14/065,756

(22) Filed: Oct. 29, 2013

(30) Foreign Application Priority Data
Nov. 19, 2012 (KR) 10-2012-0130961

(51) Int. Cl. H04L 29/06

(52) U.S. Cl. CPC H04L 63/1441
USPC 726/23

(57) ABSTRACT

Disclosed is a method of determining whether or not a website is malicious at a high speed, which determines unknown attacks, detection avoidance attacks and the like at a high speed when the website is inspected by visiting. The method of determining whether or not a website is malicious at a high speed includes the steps of: simultaneously visiting, if a list of inspection target websites is received, a plurality of inspection target websites using multiple browsers; and grasping whether or not malicious code infection is attempted through a correlation analysis of behavior information created when the plurality of inspection target websites is visited through the multiple browsers.

### BACKGROUND OF THE INVENTION

1. Field of the Invention

The present invention relates to a method of determining whether or not a website is malicious at a high speed, which determines unknown attacks, detection avoidance attacks and the like at a high speed when the website is inspected by visiting.

2. Background of the Related Art

Although a web gives us great convenience and almost all the people in the world use the web every day, it is frequently but maliciously used as a medium for spreading a malicious code without the knowledge of a user. When a website frequently visited by users is maliciously used for distributing a malicious code, it needs to pay special attention since damage of the users can be expanded greatly. Expansion of the damage incurred by the malicious code can be minimized through preemptive detection and measurement.

Since unknown attacking techniques such as malicious use of vulnerability, application of detection avoidance techniques and the like are evolved recently, detection techniques need to be enhanced. Typical methods of inspecting a website hiding a malicious code includes a low interaction web crawling detection method which is speedy but signature-dependent and a high interaction behavior-based detection method having a wide detection range and capable of detecting an unknown attack with a low speed.

However, there are a large number of websites operating on the Internet, and the number of inspection target URLs will be millions, tens of millions or more considering sub-pages. In order to perform an inspection on the large number of websites through a high interaction system, the analysis environment consuming two to three minutes to inspect one website should be improved greatly to practically use the inspection method.

### SUMMARY OF THE INVENTION

Therefore, the present invention has been made in view of the above problems, and it is an object of the present invention to provide a method of determining whether or not a website is malicious at a high speed, which promptly determines whether or not a vulnerability attack or an attempt of malicious code infection is generated.

To accomplish the above object, according to one aspect of the present invention, there is provided a method of determining whether or not a website is malicious at a high speed, the method including the steps of: simultaneously visiting, if a list of inspection target websites is received, a plurality of inspection target websites using multiple browsers; and grasping whether or not malicious code infection is attempted through a correlation analysis of behavior information created when the plurality of inspection target websites is visited through the multiple browsers.

In addition, at the step of visiting a plurality of inspection target websites, only connectible inspection target websites are visited through a preliminary inspection of whether or not inspection target websites included in the list of mass inspection target websites are connectible.

In addition, the preliminary inspection is simultaneously inspecting whether or not a plurality of corresponding inspection target websites is connectible using a plurality of threads.

In addition, the behavior information includes a file, a process and a registry phenomenon created when the plurality of inspection target websites is visited.

In addition, the correlation analysis is analyzing a correlation between file creation and process load of the created file and a correlation between file creation and registration of the created file in the registry.

### BRIEF DESCRIPTION OF THE DRAWINGS

FIG. 1 is a flowchart illustrating a method of determining whether or not a website is malicious at a high speed according to the present invention.

FIG. 2 is a flowchart illustrating a procedure of determining whether or not an attempt of malicious code infection is generated according to the present invention.

### DETAILED DESCRIPTION OF THE PREFERRED EMBODIMENT

An embodiment according to the present invention will be hereafter described in detail with reference to the accompanying drawings.

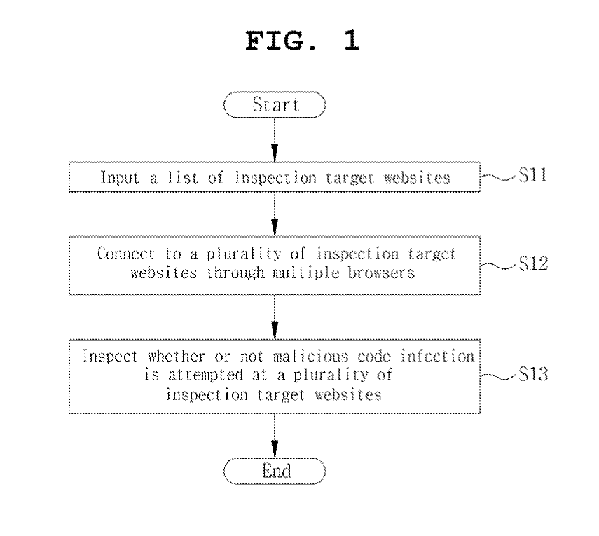

FIG. 1 is a flowchart illustrating a method of determining whether or not a website is malicious at a high speed according to the present invention.

Referring to FIG. 1, an inspection server for inspecting mass websites at a high speed according to the present invention receives a list of mass inspection target websites S11. At this point, the inspection server confirms whether or not the mass inspection target websites are connectible and performs visit inspection only on the websites confirmed to be connectible (alive). In order to confirm whether or not the inspection target websites are connectible at a high speed, the inspection server transmits a domain name system (DNS) inquiry and confirms whether or not a response is received. If a DNS response is received, the inspection server transmits a synchronization signal for the TCP 80 port, and if an affirmative response signal is received, the inspection server determines that a web service is provided through the TCP 80 port. Here, the inspection server may confirm in advance whether or not it is possible to simultaneously connect to a plurality of websites using multiple threads.

If the inspection server receives the inspection target website list, it simultaneously connects to a plurality of inspection target websites using multiple browsers S12. Here, the inspection target website list is configured of URLs of mass inspection target websites. Then, the inspection server executes the browsers by a predetermined unit of simultaneously connectible websites and visits the inspection target websites through the browsers. For example, if one hundred browsers can be simultaneously executed, the inspection server connects to the inspection target websites of the inspection target website list by the unit of one hundred.

The inspection server inspects whether or not a vulnerability attack is generated or malicious code infection is attempted in the plurality of currently visited inspection target websites S13. The inspection server may confirm whether or not an attack of infecting a website with a malicious code is generated through a correlation analysis of a file, a process and a registry phenomenon created after the inspection target websites are visited. That is, the inspection server may correctly grasp whether or not malicious code infection is attempted, through a correlation analysis such as a correlation between file creation and process load of the created file and a correlation between file creation and registration of the created file in the registry.

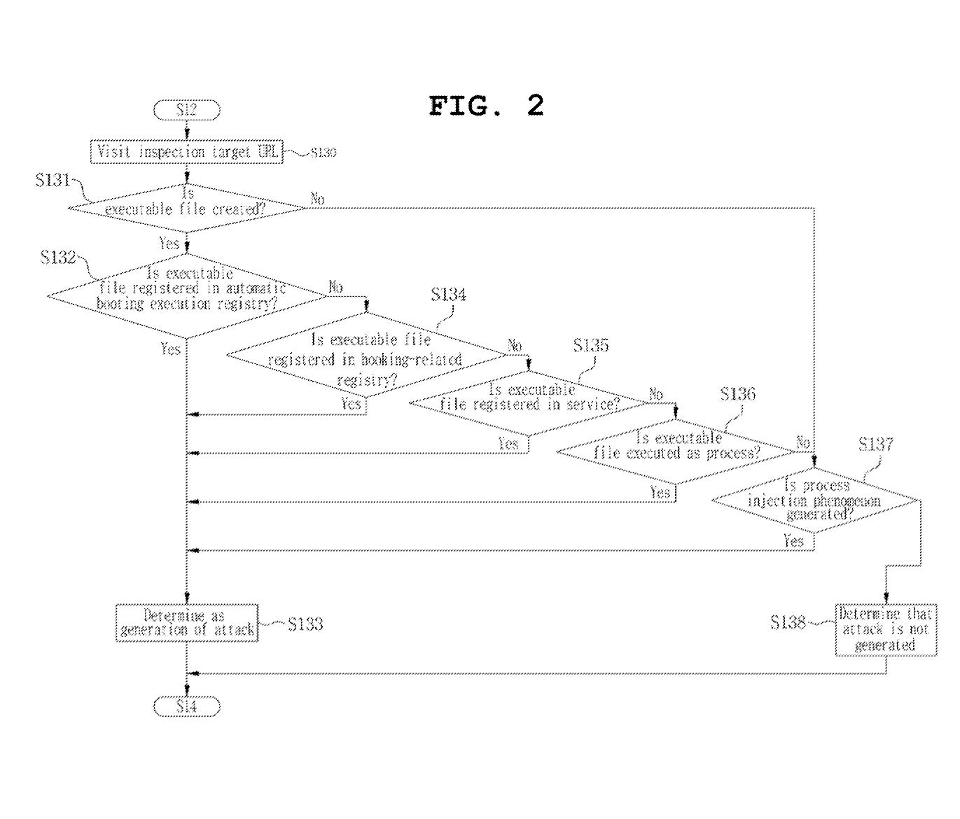

FIG. 2 is a flowchart illustrating a procedure of determining whether or not an attempt of malicious code infection is generated according to the present invention.

First, the inspection server confirms whether or not an executable file is created when a plurality of inspection target URLs is connected using multiple browsers S130 and S131.

If the executable is created, the inspection server confirms whether or not the created executable file is registered in an automatic booting execution registry S132.

If the created executable file is registered in the automatic booting execution registry, the inspection server determines that an attempt of malicious code infection is generated S133.

If the created executable file is not registered in the automatic booting execution registry, the inspection server confirms whether or not the created executable file is registered in a hooking-related registry S134. If the created executable file is registered in the hooking-related registry, the inspection server determines that an attempt of malicious code infection is generated S133.

If the created executable file is not registered in the hooking-related registry, the inspection server confirms whether or not the created executable file is registered in a service S135.

If the created executable file is registered in a service, the inspection server determines that an attack attempting malicious code infection is generated S133, and if the created executable file is not registered in the service, the inspection server confirms whether or not the created executable file is executed as a process S136.

If the created executable file is executed as a process, the inspection server determines that an attack attempting malicious code infection is generated S133.

If the created executable file is not executed as a process, the inspection server confirms whether or not a process injection phenomenon is generated S137. Here, the process injection phenomenon is generated by a vulnerability attack.

If the process injection phenomenon is generated, the inspection server determines that a malicious code infection attack is generated S133, and if the process injection phenomenon is not generated, the inspection server determines that a malicious code infection attack is not generated S138.

If the executable file is not created, the inspection server determines whether or not a malicious code infection attack is generated S138 by confirming whether or not the process injection phenomenon is generated S131 and S138.

The present invention may promptly determine whether a vulnerability attack is generated or malicious code infection is attempted at a visiting target site.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of determining whether or not a website is malicious at a high speed, the method comprising the steps of:
simultaneously visiting, if a list of inspection target websites is received, a plurality of inspection target websites using multiple browsers; and
grasping whether or not malicious code infection is attempted through a correlation analysis of behavior information created when the plurality of inspection target websites is visited through the multiple browsers.

2. The method according to claim 1, wherein at the step of visiting a plurality of inspection target websites, only connectible inspection target websites are visited through a preliminary inspection of whether or not inspection target websites included in the list of mass inspection target websites are connectible.

3. The method according to claim 2, wherein the preliminary inspection is simultaneously inspecting whether or not a plurality of corresponding inspection target websites is connectible using a plurality of threads.

4. The method according to claim 1, wherein the behavior information includes a file, a process and a registry phenomenon created when the plurality of inspection target websites is visited.

5. The method according to claim 4, wherein the correlation analysis is analyzing a correlation between file creation and process load of the created file and a correlation between file creation and registration of the created file in the registry.
